(19) United States
(12) Patent Application Publication
(10) Pub. No.: US 2009/0198577 A1
(43) Pub. Date: Aug. 6, 2009

(54) BUSINESS PROCESS, METHOD, SYSTEM AND MODEL of COMMERCE between A UNIQUE BUSINESS ENTITY that PROCURES and DISTRIBUTES ANY PRODUCT and/or SERVICE & its CONSUMERS WHOM RECEIVE SAID PRODUCTS and SERVICES by PURCHASING A SUBSCRIPTION BASED MEMBERSHIP PROGRAM that INCLUDES a SELF EMPLOYMENT PROGRAM

(76) Inventors: Robert Foreman, Burbank, CA (US); James Aldridge, Westminster, CO (US)

Correspondence Address: Robert Foreman;James Aldridge, 2239 N. Frederic Street, Unit C, Burbank, CA, 91504, US

(21) Appl. No.: 12/354,294

(22) Filed: Jan. 15, 2009

Related U.S. Application Data
(60) Provisional application No. 61/026,443, filed on Feb. 5, 2008.

(51) Int. Cl. G06Q 40/00; G06Q 10/00; G06Q 30/00

(52) U.S. Cl. 705/14; 705/1; 705/35; 705/40; 705/26

(57) ABSTRACT

The present invention relates to an exclusive method, system and model of commerce created between a unique business entity that offers, publishes, and/or distributes any product and/or service through a subscription based membership program purchased by its consumers and the unique business entities' consumers who receive said products and/or services electronically or via mail. The unique business entities' consumers simultaneously operate their own home based business program utilizing a unique viral marketing campaign and cross promotion sales process created by the unique business entity.

I claim priority to my provisional application Ser. No. 61026443, filed on Feb. 5, 2008.

### FIELD OF INVENTION

The present invention relates to an exclusive method, system and model of commerce created between a unique business entity that offers, publishes, and/or distributes any product and/or service through a subscription based membership program purchased by its consumers and its consumers who receive said products and/or services—while those consumers simultaneously operate their own home based business program through the promotion and sales of the unique business entity's paid memberships and said products and/or services OR through the combined cross promotion and sales of paid memberships, the unique business entity's said products and/or services AND the consumers own products and/or services.

One such unique business entity utilizing said exclusive method, system and model of commerce is K.E.G. Distribution & Publishing, L.L.C. (“K.E.G”).

K.E.G. shall develop, finance and procure, as well as acquire, license and bulk purchase any service and/or product of its choice, based on certain qualifying criteria, and release or otherwise distribute said products and/or services in a bundle or set (more than one) to its built in customer base who pays an agreed upon reoccurring fee (subscription) to receive said products and/or services and enjoy certain other membership benefits and privileges.

Although K.E.G. can apply its exclusive system and method to ANY product and/or service as previously stated, the company shall focus on emerging media related products such as music, movies and video games and/or other general emerging products and/or services that have not been sold, have sold only to a limited market, or products and/or services that simply could benefit from more market exposure and/or increased sales.

In addition to providing media related product and/or services to its paying subscribers/members, K.E.G. has created a method for those subscriber/members to simultaneously operate a home based business (or self employed business) that promotes and sells paid memberships of K.E.G. to interested potential customers. Said self employed business shall create multiple streams of potential revenue for K.E.G. and its members/subscribers.

K.E.G. has created a method that shall utilize its subscriber/member base to attract product service creators, developers and/or producers/manufacturers that desire to have their product and/or service financed, developed, licensed, acquired or otherwise procured and then distributed to K.E.G.'s built in subscriber/member base and the general public.

K.E.G. has created and shall implement a unique cross promotion and viral marketing method and system that subscribers/members may utilize to promote and sell their products and/or services and K.E.G paid memberships, that simultaneously and indirectly drives up the sales volume of other K.E.G subscribers/members who are also selling products and/or services, and vice versa—all while member/subscribers earn income from their own promotion and immediate direct sales of their product and/or service AND a potential income from the promotion and sales of a growing subscriber/membership base that may receive their product and/or service in the future if/when K.E.G. distributes said product and/or service to its entire subscriber/member base. This cross promotion and viral marketing process created by K.E.G. is called the “69 Viral Marketing & Cross Promotion Sales and Distribution Process.”

K.E.G. shall also license and/or otherwise acquire other exclusive and/or non exclusive retail products and/or services from buyers and/or manufacturers and sell those specific products and/or services on its e-commerce website and/or through other traditional means such as a magazine, kiosk or retail store. Said products and/or services shall, however, be on display only. K.E.G shall promote and facilitate the sale and shipping of said products and/or services but the customer shall pay for delivery and/or receipt of said products and/or services and shall receive them directly from product buyers, sales agents, or manufactures.

Products and/or services sold in this precise fashion shall not be marked up for profit, but sold below or near minimum cost to K.E.G.'s member/subscriber consumers. Said products and/or services shall not be available to the general public unless they purchase a K.E.G. membership for a minimum of one reoccurring billing cycle after which time the customer may cancel if they desire. K.E.G does not desire to make a profit from the sale of said products and/or services, but rather is executing said sales method as an incentive to current members/subscribers to retain their membership, to sell more K.E.G. memberships by offering products and/or services at such competitive prices compared to other retailers and to promote and create brand awareness of K.E.G. in general.

K.E.G. shall implement a unique process and method whereby it shall pay product developers to test new products and/or services or prototypes. K.E.G. shall then pay its members/subscribers to provide comprehensive beta testing and/or market testing to the product and/or service developers. K.E.G., utilizing its overall business process and method, shall offer select product and/or service developers payment to market test or beta test certain products and/or services on its member/subscriber base. In exchange, said product and/or service developers shall receive preliminary reports based on a variety of aspects with regard to their product including but not limited to: product and/or service effectiveness, durability, likeability, potential pricing, content appeal and any other information said product and/or service developers are interested in receiving. K.E.G. shall then offer select members/subscribers, who have provided the best reports to and in accordance with the product and/or service developer, payment for further and more comprehensive testing. Said payments shall be deducted from K.E.G. payments to the product and/or service developer in full, or in part, relative to what K.E.G paid the product and/or service developer. This unique method and process of product and/or service testing shall provide incentive and reduce and/or eliminate expenditures of product and/or service developers that require beta/market testing of their products, while simultaneously offering payment and yet another incentive to paying members/subscribers of K.E.G.

K.E.G shall utilize funds generated from its paying members/subscribers to create a unique financing and co-production/manufacturing program for selected individuals that have emerging products and/or services that require funding for the purpose of conceptual emerging product and/or service procurement. K.E.G. shall then distribute said emerging products and/or services to its paying members for feed back, beta testing and/or as a completed product and/or service.

K.E.G has established a unique system for tracking promotional sales of K.E.G paid new memberships sold by its own members/subscribers that are simultaneously promoting K.E.G. paid memberships coupled with said member/subscriber's own unique product and/or service. This tracking system shall then be utilized by K.E.G. to determine if and/or when to release its paying members/subscribers' original product and/or service to its entire member/subscriber base. Because the companies overall method and process is designed to slowly and steadily increase in overall membership/subscriptions, whose total member/subscriber base is equal to that of the total volume that product and/or services shall be distributed, K.E.G. shall utilize the unique tracking system to allow participants that are promoting their original product coupled with membership to continue promoting for as long as possible before their product is actually released and/or distributed to all of K.E.G.'s members/subscribers. This system allows K.E.G. to benefit from the maximum amount of promotion of its paid memberships from a participant that is promoting while it also allows the participant, by default, a higher total volume of members/subscribers—through their own promotion and the company's overall promotion—to sell to when that product is ultimately released.

The tracking system shall also be utilized to create competition among participants that are attempting to have their product and/or service released to K.E.G.'s total volume of paying member/subscribers. The tracking system shall also be utilized to create competition amongst participants who are going to have their product and/or service released to K.E.G.'s total volume of paying member/subscribers, but whom can manipulate that schedule in their favor by outselling their respective competitors. Typically, the later a product/service is release by K.E.G., the more of the participants total product and/service shall be distributed as K.E.G.'s customer base is designed to be always steadily climbing. If in the event K.E.G's member/subscriber base is descending then the schedule may reverse itself allowing the top selling participant to release their product first when membership/subscriptions are at its highest.

The combination of K.E.G.'s unique methods and systems (as described herein) and its self employment opportunity—fused with the company's “69 cross promotion & viral marketing and sales distribution process”—not only creates a unique model of commerce between K.E.G and its total subscriber/member base who may be selling their own original product and/or services to K.E.G's members/subscribers, but it also creates a overriding phenomena or system whereas the primary product that K.E.G. is offering (i.e. its paid membership and accompanying benefits) has enough stand alone value relative to its price as to make K.E.G.'s supplementary products and/or services (i.e. products and/or services created by its paying members or other individuals and released on a reoccurring basis to all members/subscribers) complimentary relative to the primary product. This phenomenon and system created allows K.E.G.—utilizing a mathematical formula to evaluate cost versus expense to determine precise profit margins that may be paid out to product and/service developers—to procure and distribute a mass quantity of emerging, prototype, and/or other under exposed products and/or services with virtually no risk to K.E.G.'s financial bottom line.

Allocations of profits as determined by the mathematical formula can then be utilized to pay K.E.G.'s members/subscribers or any other individual a great deal of income for the distribution of their emerging, prototype, and/or under exposed products and/or services in a way that few purchasers, buyers, distributors and/or or retailer can not offer or execute.

After products and/or services have been exposed to K.E.G. closed market of members/subscribers, the company can then get feedback about the product from its members/subscribers. Certain product may be further developed, re-licensed to external buyers, sales agents, distributors and/or retailers for profit, or sold to the general public on K.E.G.'s e-commerce website and/or kiosk or retail store or by some other traditional method.

### BACKGROUND OF THE INVENTION

Merchants, distributors, publishers and even some retailers have effectively sold subscription based memberships to their respective customers for years. Typically, a subscription based membership allows a customer to receive a product and/or service, or multiple products and or services, for a fee that is charged to the customer on reoccurring basis and/or interval of time such as week to week, month to month, or year to year. Typically, said products and/or services received in such fashion are discounted from the suggested retail price, thereby creating incentive for the potential customers to purchase a subscription and/or membership to receive said products and/or services.

Examples of several companies, to name just a few, that offer said subscription based memberships for products/services as described in the previous paragraph are Publisher's Clearing House, Time Warner Cable, AOL, Direct TV, Net flicks, HBO, and Ever Quest (video game). Each offers a uniquely different product and/or service, or multiple products and/or services, for a fee that is charged to the customer on a reoccurring basis (usually month to month) in order for that customer to continue receiving or making use of said products/services received in such fashion.

Merchants, distributors, publishers and even some retailers have also created incentive based programs whereas they encourage their respective subscribers to promote or otherwise refer memberships and/or subscriptions to their friends and/or family, or any other individual, in order to receive a discount on their current membership if said friends and/or family or other individual ultimately purchase a subscription/membership. That discount is typically equal in value to one reoccurring fee that the current customer pays for said subscription/membership. These programs are usually referral programs only and are not set up in a fashion where the subscriber has a license to sell such memberships. Therefore, they do not actually receive cash or a unit of currency, but rather, just a discount on their current subscription as previously described. In some cases, companies that offer subscription based memberships offer cash incentives such as a paid commission to its subscribers/members if they refer another individual who then purchases a membership and/or subscription to the company. Either method of promotion and marketing is typically called “viral marketing”, whereas one customer refers another refers another through direct, and sometimes, indirect communication.

K.E.G. shall offer a similar subscription based paid membership program to its potential customers. A) K.E.G. shall automatically license to its customers the right to sell K.E.G memberships, as opposed to just offering a referral program. B) K.E.G. shall pay a flat commission for memberships sold based on referral. C) K.E.G. shall offer a “residual” payment to members who have sold memberships, so long as the refereed member/subscriber maintains said membership/subscription.

K.E.G. is not a MLM (multi level marketing) company. K.E.G. charges all members on a reoccurring basis, such as month to month, if its customers choose to maintain their membership and benefits. K.E.G only pays a commission to a member/subscriber for the direct or indirect referral of another purchasing member. K.E.G. does not pay a commission or residual to members/subscribers' “downline” of referred members/subscribers such as a typical MLM company might do.

K.E.G.'s method of selling memberships to subscribers, its offering of products and/or services as well as the offering other benefits along with the membership, and its method of paying commissions and/or residuals to its members/subscribers for referrals that purchase memberships, is not unique unto itself and varies little from other companies that execute the same business method or execution of such method.

The uniqueness of K.E.G. and its associated process, methods and systems directly relates to the actual “type” of products and/or services that K.E.G is procuring and/or distributing, “how” those products are procured and distributed, “in association with” an applied system that is a unique specific mathematical formula executed to evaluate, project and facilitate financing and/or payments made to K.E.G or product and/or service developers, respectively, of said type of products and/or services—combined with the execution of K.E.G.'s “69 Viral Marketing & Cross Promotion and Sales Distribution Process” which relates to method of promoting, marketing and selling products and/or services and K.E.G. memberships together. K.E.G.'s focus shall be directed to the procurement and distribution of “emerging product and/or services” and shall bundle said emerging product and/or services with non emerging product and/or services and distribute said bundle of products and/or services to its paying members/subscribers on a reoccurring basis equal to their payment schedule, such as month to month, for example. Other subsets or “types” of products and/or services procured and distributed by K.E.G are: established products and/or services that have been sold to a limited market, products and/or services that have no market, products and/or services that are subjective in consumer appeal such as artistic products and/or services like books, motion pictures, video games and music and/or artistic related services, products and/or services that are “prototypes”, products and/or services that need beta testing or market testing, and conceptual products and/or services that are “idea based” and not yet financed and/or produced/manufactured such as but not limited to motion pictures, television programs, video games and any other type of “invention” or business that provides a service. All of these “type” of products and/or services procured and distributed by K.E.G. shall be referred to herein as “emerging products” or simply “products and/or services” by definition.

K.E.G.'s “procurement” of said emerging products and/or services shall consist of any one or all methods of product and/or service: acquisition, purchase, development, financing, manufacturing, producing and replication and/or duplication.

K.E.G.'s “distribution” of said emerging products and/or services shall consist of any one or all methods of distribution including but not limited to: products and/or services distributed on a reoccurring cycle in direct correlation with member/subscriber reoccurring payment, products distributed on K.E.G.'s e-commerce website, products and/or services sold on an affiliate e-commerce or traditional website, products and/or services sold at a K.E.G kiosk and/or retail store, products and/or services sold from a K.E.G. magazine or publication, products and/or services that have been re-licensed to external companies such as a purchaser, sales agent, distribution hub and/or company, merchant, wholesaler and/or retailer. The term “distribution” as defined herein shall encompass any one or all of said methods and shall also comprise of the “delivery and/or confirmed customer receipt” of said products and/or services.

A product and/or service developer and/or individual that is attempting to develop, finance, produce/manufacture, perform market research, beta test and/or market test, advertise, promote, market and secure distribution for an emerging product and/or service must undergo a monumental task that is extremely time consuming and expensive. Said task is often so time consuming and so expensive that it is just not possible for certain individuals and/or certain products and/or services to secure any singular faction of development, financing, production/manufacturing, market research, market testing/beta testing, advertisement, promotion, marketing and distribution, much less “all combined factions” necessary to procure and distribute emerging product and/or service.

Additionally, certain emerging products and/or services that have been procured and distributed to consumers face stiff competition and/or lack the financial backing necessary to allow said emerging products and/or services to be exposed to a wider market and to enjoy increased sales from such exposure. Currently there are few standard processes, systems, or methodologies that may greatly enhance or improve upon the traditional method of procuring and distributing an emerging product and/or service. Each product developer and/or individual must overcome said monumental task by any means necessary in order to achieve even the smallest measurement of product and/or service procurement and distribution and is usually limited to direct sale of their products and/or service through the internet, small retail store, their home and/or other “less than advantageous” method of procurement and distribution for years before said emerging product and/or service is ultimately licensed, purchased, and/or distributed in mass and/or to a larger venue and/or market and/or before any real profit is earned.

Additionally, because there are so many factions, as previously described, that each require a small percentage of the suggested retail price of any given product/and or service in order to effectively perform their unique function, the product and/or service developer's royalties from all sales are severely diminished. Sometimes said sales are so severely diminished that the product and/or service developer receives no profit whatsoever. In other cases, any profit earned in the form of an advance to the product and/or service developer, must be recouped in the future, often at the expense of the product and/or service developer's “next emerging product”.

The current and traditional method and system of product and/or service procurement and distribution on a mass scale is most effective for large companies and/or corporations that have millions or sometimes billions in assets and financial resources. Said traditional method and system for achieving profitability from product and/or service procurement and distribution is severely prejudiced in their favor and not in the favor of the emerging product and/or service developer and/or individual. Two industries where said traditional method and system of product procurement and distribution on a mass scale, and profit participation, is severely prejudiced in favor of large companies and/or corporations that have millions or sometimes billions in assets and financial resources is the motion picture industry and the music industry.

The current and traditional method and system of emerging product and/or service procurement and distribution on a mass scale does not necessarily favor the established companies and/or corporations with large assets and financial resources because of just hoarding or greed. Such traditional methods and systems are in place and/or otherwise practiced and executed because the large company and/or corporation must take a majority of the financial risk associated with procurement and distribution of emerging products and/o services. For every successful emerging product and/or service procured and distributed by said large companies and corporations, there are many other emerging products and/or services that are not successful and create a financial drain on the large company and/or corporations' assets and/or financial resources. Because of such risk factors, said companies must subsidize losses of unsuccessful ventures by proverbially “taxing” the successful ventures. Unfortunately, it is quite often the emerging products and/or services developers that bare the brunt of this proverbial tax; each and every one of them. Again, two industries that greatly utilize this proverbial tax the success system as applied to emerging products are the motion picture industry and the music industry.

The motion picture industry and the music industry distributes product that is considered commercial art and that commercial art is very subjective as related to customer appeal. The motion picture and music industry, more so the former than the later, assume great financial risks for procuring and distributing their respective product because of the very subjectivity of that product. Therefore, the motion picture and music industry must subsequently execute the “tax the successes” method more than almost any other industry. However, in the motion picture industry specifically, it is often such an expensive endeavor to produce a motion picture that it is often considered a huge financial risk for a product developer (independent motion picture producer) and any affiliate investors because of the “tax the successes” system utilized by the motion picture industry. Even if a product is financially successful, the large company and/or corporation shall still earn a majority of any profits. This practice discourages investors considering motion picture investment and often discourages first time motion picture producers from every producing another motion picture, regardless of their potential talent or critical acclaim.

K.E.G., utilizing all of its combined methods and systems in conjunction with the execution of its “69 Viral Marketing & Cross Promotion, Sales and Distribution Process” greatly enhances and improves the traditional method and system of procuring and distributing emerging products and/or services on a mass scale for respective emerging product and/or service developers and/or individuals.

K.E.G shall also, utilizing all of its combined methods and systems in conjunction with the execution of its “69 Viral Marketing & Cross Promotion, Sales and Distribution Process” greatly enhance and improve the traditional method and system of procuring and distributing emerging products and/or services with little to no risk to K.E.G.'s own financial assets and resources, thereby eliminating the need to proverbially “tax the successes”. By default, this shall allow more profit participation for product and/service developers that have procured and distributed products and/or services through K.E.G.

K.E.G. shall achieve said enhancement and improvements to the traditional method and system of emerging product and/or service procurement and distribution by implementing a combination of methods, processes and systems designed to achieve a desired and precise result that may be calculated based on a unique mathematical process.

(K.E.G. shall offer a variety of membership/subscription programs, each that vary in price. However, the mathematical formula utilized in the following demonstration and as applied to all programs and their respective pricing is based on percentages that are proportionately the same. Therefore K.E.G. shall use herein the term “unit” to represent any unit of price, regardless of that units' physical monetary “value” as it relates to total price of one membership/subscription program versus another. [i.e. $25 (US) subtracted by $5 (US) represents 20 units subtracted by 5 units. Just as, $250 (US) subtracted by $50 (US) still represents 20 units subtracted by 5 units, just as £2500 subtracted by £500 still represents 20 units subtracted by 5 units.])

K.E.G shall charge a potential customer 50 units to purchase a membership/subscription. From said sale, 25 units shall be allocated to K.E.G. for operational expenses. If a member/subscriber sells a membership/subscription to another purchasing customer, then that member/subscriber shall receive 20 units as a commission for the sale. The remaining 5 units shall be allocated to K.E.G for operational expenses. If K.E.G. is exclusively responsible for the sale of a membership/subscription, as opposed to such sale being obtained by referral of a K.E.G. subscriber/member, then K.E.G shall allocate all 50 units for operational expenses.

After purchasing the initial membership/subscription, each K.E.G. member/subscriber must pay 25 units on a fixed reoccurring basis or interval of time (“cycle”) such as, month to month for example, and as determined by K.E.G., in order to receive emerging products and/or services distributed by K.E.G. and to enjoy all related membership/subscriber benefits during a cycle.

Each member/subscriber shall earn 1 unit per cycle as a residual payment for each and every purchasing customer referred to K.E.G. who is currently maintaining a membership/subscription and paying 25 units per cycle. If a purchasing customer cancels the membership/subscription, the referring member/subscriber shall cease receiving a residual for that particular cancelled member/subscriber.

Of the 25 units paid from each and every member/subscriber during a cycle, K.E.G shall allocate 1 unit from each group of 25 units of each and every member/subscriber for each emerging and/or established product and/or service that K.E.G. shall finance, acquire, purchase, produce/manufacture and intends to distribute in a cycle to all members/subscribers of K.E.G in that cycle. (For example if K.E.G.'s current total membership/subscription base is 100,000, then K.E.G. shall allocate 100,000 units for the financing, acquisition, production/manufacturing of that emerging and/or established product and/or service that K.E.G shall distribute/release to all 100,000 members/subscribers.)

K.E.G. shall bundle, or otherwise combine, at least two and/or three emerging products and/or services, or more than three in certain instances, that shall be released/distributed to K.E.G.'s entire member/subscriber base each and every cycle. Emerging “services” shall be redeemed or otherwise received by members/subscribers in any method determined by K.E.G. such as by distributing a redeemable ticket or coupon that the member/subscriber may then redeem for use of said emerging service.

Each and every distribution cycle, K.E.G shall allocate 5 units from every 25 units received from its entire member/subscriber base to pay for the distribution/delivery/download (if electronic)/or customer receipt of the bundle of emerging and established products and/or services released in one cycle.

Each and every distribution cycle, K.E.G shall allocate 6.5 units from every 25 units received from its entire member/subscriber base to pay for general operational expenses during that cycle.

Each and every distribution cycle, K.E.G shall allocate 1 unit from every 25 units received from its entire member/subscriber base to pay all membership/subscriber residuals. K.E.G shall retain all residuals from members/subscribers referred to K.E.G. by K.E.G or when no other subscriber/member is responsible for a referral that leads to a purchase of a membership/subscription.

Each and every distribution cycle, K.E.G shall allocate 3 units from every 25 units received from its entire member/subscriber base to pay for each emerging and/or established product and/or service that K.E.G. shall finance, acquire, purchase, produce/manufacture and intends to distribute and/or release in the “next” cycle to all members/subscribers of K.E.G in that one cycle.

Each and every distribution cycle, K.E.G shall allocate the remaining 6.5 units from every 25 units received from its entire member/subscriber base to pay for all other miscellaneous operational expenses incurred during a cycle.

As previously described, the 1 unit allocated for each emerging and/or established product and/or service (of the 25 units paid from each and every member/subscriber during a cycle) that is distributed in a cycle shall be paid to either K.E.G., or the emerging and/or established product developer depending on if the emerging product and/or service is a procured internally by K.E.G. or externally by the emerging product and/or service developer and/or individual.

Utilizing the unique mathematical formula as developed by K.E.G. and previously described, K.E.G. can determine precisely how many units, minimally, it must allocate to finance or pay product and/or service developers, respectively, to acquire, purchase, produce/manufacture and distribute in a cycle, each emerging product and or service, based on the total membership/subscription base currently maintaining subscriptions/memberships. (For example, if K.E.G. currently has 1,000,000 members/subscribers, then—utilizing the mathematical formula to evaluate and make a determination—K.E.G may allocate for financing or pay emerging and/or product and/or service developers, respectively, a minimum of 1,000,000 units for the procurement and/or distribution of said emerging products and/or services.) Additionally, any increases in K.E.G memberships sold before the product's and/or service's distribution/release cycle shall be calculated and added onto the minimum payout figure proportionately.

The mathematical formula created by K.E.G., utilized in conjunction with all its other process and methods, greatly improves upon and enhances the traditional method and system for the procurement and distribution of emerging products and/or services because it calculates precise minimum expenses AND payouts for both K.E.G. and/or the product and/or service developer, respectively, in order to determine the economical viability of procuring and distributing any specific product and/or service. This process shall occur utilizing the method and system, rather than relying on risk based factors that may effect sales, such as but not limited to: emerging product and/or service brand awareness, product quality, subjectivity of artistic products, effectiveness of promotion and/or advertising campaigns, and potential product and/or service returns. (Members/subscribers may cancel membership but may not return products and/or services unless the entire membership and all benefits, including residual payments, are also forfeited.)

Additionally, it is an estimated industry standard that emerging products and/or services may lose as much as 50%- 70% of its gross profit margin after net deductions have been made from all expenses related to traditional methods and systems of emerging product and/or service procurement and distribution, as previously described. K.E.G.'s methods and systems for procuring and distributing emerging product and/or services allows product and/or service developers to earn 100% of the revenue that is precisely projected and immediately earned from the proverbial “pre-sale” and distribution of their emerging products and/or services to K.E.G.'s entire member/subscriber base, as opposed to: A) relying on inconclusive sales projections, and B) having any number of contributing factors and/or companies chipping away at their gross profit margins before they ever receive payment, if they receive payment at all.

1 unit may not initially sound like a great deal of payment for “certain” emerging products and/or services sold utilizing K.E.G's methods and systems of product and/or service procurement and/or distribution, depending upon the expense of procuring said emerging product and/or service and the current number of K.E.G.'s paid members/subscribers. However, a product and/or service sold utilizing traditional methods and systems of product and/or service procurement must, according to industry standards, sell for anywhere between 2 units through 7 units in order to achieve that exact same profit margin of 1 unit utilizing K.E.G's methods and systems of product and/or service procurement and/or distribution.

Subsequently, a 1 unit profit margin may sound fantastic for certain other emerging product and/or service developers when the alternative is no profit because the larger companies and/or corporations that practice traditional methods and systems for procuring and distributing emerging product and/or services can not, or may not, take the previously described risks associated with mass procuring and/or distributing certain products and/or services. This especially holds true for artistic products due to their subjectivity in the marketplace. K.E.G, utilizing its mathematical formula, does not assume these same risks and shall be much more prone to acquire and or procure and distribute a greater variety of unproven and/or speculative emerging products and/or services.

Additionally, emerging products and/or services procured and distributed by K.E.G through a release cycle may earn additional profits from retail sales on K.E.G.'s e-commerce website and through the re-licensing of said emerging products and/or services to larger companies and/or corporations that apply more traditional methods and systems for emerging product and/or service distribution. Emerging products and/or services procured and distributed by K.E.G through a release cycle enjoy a greater market share and more market exposure than emerging products and/or services that have not been mass distributed. In many cases, said market exposure and sales track record shall even create incentive for larger companies and/or corporations—that apply the traditional methods and systems for emerging product and/or service distribution—to purchase, license or otherwise acquire said distributed emerging K.E.G. products and/or services because said products and/or services have a certifiable sales track record, and other proven factors associated with their release, that eliminates or diminishes risk, or at the very least, assists in the evaluation process of said larger companies and/or corporations when considering said acquisition of a K.E.G. distributed emerging product and/or service. If a K.E.G. distributed emerging product and/or service is ultimately purchased, relicensed or otherwise acquired by said larger company and/or corporation, the joint venture merely creates more market exposure and potential revenue for both K.E.G and the product and/or service developers' emerging products and/or services.

K.E.G's primary product is its paid memberships and accompanying benefits. K.E.G. has purposely and intentionally developed many processes, methods and systems designed to retain membership/subscription, other than K.E.G.'s secondary products and/or services which are the emerging products and/or services received by its entire members/subscriber base every reoccurring cycle.

The uniqueness of K.E.G's process and method of developing a primary product accompanied by secondary products and/or services and marketing both by utilizing a marketing system that is K.E.G.'s “69 Viral Marketing and Cross Promotion, Sales and Distribution Process” as previously described, is that the secondary emerging product and/or services, procured and distributed based on the unique mathematical formula developed by K.E.G. becomes almost complimentary by design. Therefore, these secondary emerging products and/or service can be procured and distributed with no financial risk to K.E.G.'s bottom line, allowing a great variety of speculative, subjective, prototype or otherwise untested emerging products and/or services to be released/distributed on a consistent basis to a new and growing market which is K.E.G's entire member/subscriber base. K.E.G. manages to do this by utilizing only a small portion of its operating funds generated from the sale of its primary product to supplement the entire expense of financing, developing, acquiring, producing, manufacturing and/or otherwise procuring, marketing and distributing its secondary product to its members/subscribers. This method and process of emerging product and/or service procurement and mass distribution is unprecedented in general commerce and a vast improvement upon the current traditional method and system for procuring and distributing said secondary emerging products and/or services and certain other more established secondary products and/or services.

K.E.G.'s process and method for retaining membership/subscribers involves the combination of many processes, methods and systems developed by K.E.G. for the purpose of executing said objective. These are as follows:

Memberships/subscriptions sold come with a license to sell memberships to interested customers, whereas the referring member/subscriber shall receive commissions.

Memberships/subscriptions that are maintained shall earn the referring member/subscriber residuals (1 unit) per each referral each and every release cycle for as long as the referred member/subscriber maintains said membership/subscription.

Residuals are forfeited if a member/subscriber cancels the membership and/or does not make a payment of 25 units on a reoccurring basis, such as month to month for example. Depending upon the number of memberships/subscriptions a referring member has sold and how many of the referred member/subscribers have maintained said membership/subscription, residuals could literally equal several thousand units per release cycle, such as month to month for example.

Members/subscribers may purchase a variety of established high priced retail products and/or services from K.E.G.'s e-commerce website and/or other retail outlet such as magazine, kiosk and/or retail store at a substantially reduced price or, in certain instances, said products and/or services may be purchased at true manufactures' cost.

Member/subscribers shall be offered certain emerging “prototype” products and/or services that may be marketed and/or beta tested by the members/subscribers that provide detailed reports. Selected members/subscribers shall be paid by K.E.G an hourly wage to test said prototype products for developers.

Members/subscribers that have original emerging product and/or services to sell may benefit from the “69 Viral Marketing & Cross Promotion, Sales and Distribution Process” so that they may create several revenue streams of income generated from the cross promotion and sales of their own original emerging product and/or service coupled with K.E.G. paid memberships, while simultaneously and indirectly driving up the sales of other original emerging products and/or services that are being promoted by other K.E.G members/subscribers and vice versa.

Members/subscribers with “conceptual” emerging products and/or services not yet produced, manufactured or completed may promote and sell K.E.G memberships and earn additional income including commissions and residuals that may, if desired, be utilized to help subsidize the cost of further development of their conceptual emerging products and/or services.

Members/subscribers who have their own original emerging products and/or services shall benefit from K.E.G.'s unique tracking and scheduling system designed to maximize the promotions and sales of K.E.G. paid memberships—while simultaneously, and by default, benefiting competing members/subscribers, with the highest membership sales, by potentially allowing their respective emerging products and/or services to be released later in a cycle, a process that shall sequentially generate more income from any potential increases in K.E.G's entire member/subscriber base that ultimately receives said emerging products and/or services.

Members/subscribers who have their own “conceptual” original emerging products and/or services shall benefit from K.E.G.'s unique tracking and scheduling system designed to maximize the promotions and sales of K.E.G. paid memberships—while simultaneously, and by default, benefiting competing members/subscribers, with the highest membership sales, by potentially selecting their “conceptual” original emerging products and/or services for financing, production, and or manufacturing for the purpose of distributing/releasing them in a cycle, a process that shall sequentially earn emerging product developers income from said distribution and release of their manufactured/produced/completed emerging products and/services. Said unique tracking system shall also be available to the general public so that they too may track certain emerging product and/or service developers and contact them for financing purposes or any other support.

Lastly, Members/subscribers shall receive two (2) to three (3) or more emerging K.E.G. secondary products and/or services every cycle along with all the other membership benefits.

Specific to K.E.G.'s exclusive method and process of “financing” conceptual emerging product and/or services, especially motion picture financing, the methods and process utilized by K.E.G., in conjunction with its “69 Viral Marketing & Cross Promotional, Sales and Distribution Process” greatly improves the current method and systems when certain conceptual emerging product and/or services are coupled with private investment in order to achieve financing for product and/or service production and/or manufacturing.

Emerging product and/or service developers that are attempting to finance production and/or manufacturing through private investment must abide by the Securities & Exchange Commission (S.E.C.) laws for selling private investment securities. Said private investments can not be advertised in any public forum of any kind unless said emerging product and/or service developer has established a company this registered with the S.E.C. as a public entity and/or has created a public offering. Establishing said public entity that is able to make public offerings, as well as advertise the sale of securities publicly, can be more difficult and/or more expensive than actually financing the specific emerging product and/or service that the conceptual emerging developer desires to create. Therefore, most emerging product and/or service developers (or motion picture producers) are limited to the private solicitation of investment securities. This creates an exposure challenge, especially for emerging products and/or services such as an independent film that only requires, for example, $30,000 to finance. The emerging product and/or service developer, or motion picture producer must make as many people as possible aware of the investment in order to achieve financing but is not allowed by law to advertise said investment. This challenge—coupled with the fact that speculative investments such as motion picture investments are considered very risky, due to both the subjectivity of the product (or motion picture) and because of the traditional processes and methods that major studios and their smaller counterparts utilize to distribute emerging product such as the proverbial “taxing the successes” method as previously stated—makes motion picture financing extraordinarily difficult to achieve in certain instances. These challenges especially apply to unproven, very new or first time conceptual emerging product and/or service developers (or motion picture producers).

K.E.G shall improve upon the traditional methods and systems of financing conceptual emerging products and/or services coupled with investment by utilizing several unique methods. Upon evaluation and execution of its unique mathematical formula, K.E.G.'s shall offer both distribution and a precise guaranteed payment for the financing and acquisition of selected said conceptual emerging products and/or services and may do so without assuming financial risk as previously stated. As applied to low budget motion pictures (motion pictures that have budgets less than one hundred thousand dollars), this method of financing can not easily be executed on a consistent basis by utilizing traditional emerging product financing and distribution methods as previously stated. Furthermore, said K.E.G method also eliminates much of the risk that an investor must assume when considering emerging product and/or service (or motion picture) investment because it has guaranteed distribution and precise profit margin equal to or greater than the associated budget, thereby making it less challenging for the emerging product and/or service developer to secure said investment.

Emerging product and/or service developer (or motion picture producer) may not be able to publicly advertise investment for their conceptual emerging product and/or service (or motion picture) but they may utilize K.E.G.'s “69 Viral Marketing & Cross Promotion, Sales and Distribution Process” to promote and sell K.E.G. memberships along with their conceptual emerging product and/or service without violating any S.E.C. laws. The reason is because the emerging product and/or service developer is not selling an investment in the actual conceptual emerging product and/or service, but rather, is selling a paid membership of K.E.G. Such public exposure and legal advertising shall, by default, naturally create more “one on one” situations whereas a conceptual emerging product developer (or motion picture producer) can then privately solicit private investment on a project that has guaranteed distribution and precise profit margin equal to or greater than the associated budget.

### SUMMARY OF THE INVENTION

A unique business entity that sells a primary product that is a subscription based paid membership program that offers multiple benefits and includes secondary emerging products and/or services that are bundled and distributed to the unique business entities entire member/subscriber base on a reoccurring cycle such as month to month, for example.

The unique business entity offers a self employed business program that is included with the unique business entity's membership/subscription that allows its members/subscribers to earn commissions and residuals for selling paid memberships to new customers.

The unique business entity has created a system comprised of a unique mathematical formula utilized to evaluate and determine, with precision, the economic viability and/or precise profit margin of any secondary emerging product and/or service the unique business entity desires to procure and distribute to its entire subscriber/member base and is a system that is executed with very little financial risk to the unique business entity.

The unique business entity has created a method that utilizes a viral marketing, cross promotion and sales technique, coupled with distribution, that its members/subscribers may execute when promoting and selling their own original emerging products and/or services coupled with paid memberships of the unique business entity—that simultaneously and indirectly drives up the sales volume of other subscribers/members who are also selling products and/or services, and vice versa. This process is called the “69 Viral Marketing & Cross Promotional, Sales and Distribution Process”.

The unique business entity has created multiple methods and systems designed to retain members/subscribers including: forfeited residuals if a membership is canceled, an e-commerce website and or other outlet such as a magazine, kiosk and/or retail store where subscribers/members can buy certain products at manufacturers cost, payment for beta/market testing prototype emerging products and/or services, a method for promoting, financing, selling and/or otherwise procuring members/subscribers own conceptual emerging products and/or services, a cross promotional program designed to directly and indirectly increase sales of product and/or service developers emerging products and/or services and the offering of emerging products and/or services distributed on a reoccurring basis to all members/subscribers.

The unique business entity has created multiple tracking systems designed to facilitate maximum promotion of the unique business entity's products and/or services through competition between participants and that creates a method for the unique business entity to schedule the distribution of its secondary emerging products and/or services.

The unique business entity has created a method and system for financing original conceptual emerging product and/or services for product and/or service developers that guarantees distribution, precise profit margins utilizing the mathematical formula created by the unique business entity, and allows product and/or service developers to publicly advertise their conceptual emerging product and sell memberships/subscriptions to raise capital, without publicly advertising their investment offering, a method that inadvertently creates more one on one situations with potential investors where the emerging product and/or service developer may privately offer investment opportunity in way that does not violate Securities and Exchange Commission laws specific to the non public offering of private securities.

The unique business entities combined methods, processes and systems effectively creates a three dimensional and spherical commerce model similar to a “built-in mini economy amongst paying members” where any one or more entities associated can systematically create or otherwise facilitate the finance, manufacturing, production, promotion, marketing, advertisement and distribution of its combined products and services while each entity directly and indirectly generates an income from participating paying members. Meanwhile, the unique business entity maintains itself economically and earns a substantial profit from being the facilitator of the unique commerce model created and is the main economical beneficiary of such a unique commerce model.

1. A method and model of commerce that allows a unique business entity—such as a distributor, wholesaler, publisher, and/or merchant that delivers, disperses, leases, rents or otherwise sells a product and/or service, or business entity's whose function is to create, manufacture, produce, market, publicize, advertise and/or distribute goods, products and/or services to a potential or current customer base “that is a paying or non paying subscription based member of said unique business entity”—to benefit from a formulaic, cross promotion and viral marketing campaign designed to facilitate and improve the overall process and functionality of the unique business entity, its paying or non paying members of said unique business entity, the earning potential and profitability created through multiple revenue streams generated by the unique business entity and its paying or non paying subscriber based members, as well as the procurement of any product and/or service creation, development, financing, manufacturing, production, promotion, marketability, advertisement, sales volume, and exposure associated to both the unique business entity and its paying or non paying subscriber based members.

2-51. (canceled)

52. The unique business entity as described in claim 1) shall sell advertising to its paying or non paying members, or any other potential customer it desires, by offering to include said advertising on its website as described by claim 94), or on its Kiosks as described in claim 77), or by including said advertisement in and/or on its packaging of products and services distributed as described in claim 95) and to be shipped in a cycle as described in claim 95), or distributed as described by claim 77), or by any other general and traditional method.

53-76. (canceled)

77. The unique business entity as described in claim 1) shall utilize funds from its operating capital in reserve (operating expenses) as described in claim 96) to cash flow the expense of establishing retail stores and/or kiosks that perform the same function as described in claim 94) and that offer paid memberships to potential customers as described in claim 94) as well as any product and/or service that could be sold in a retail store and/or kiosk as opposed to an e-commerce website, and the unique business entity shall also offer promotional memberships coupled with other product and/or services at such retail stores and/or kiosks whereas; a majority of products that are sold at retail stores and/or kiosks in this manner shall be on display only and may not necessarily be received by potential customers or paying members as described in claim 94) at said retail stores and/or kiosks, but rather, said products purchased by potential customers or paying members shall be shipped via mail or delivered from the product manufacturer to the potential customers and/or paying members however the manufacturer and/or the unique business entity typically delivers said products, and all commissions and any potential residuals earned by the unique business entity from the sale of paid memberships as described in claim 94) from paying members as described in claim 24) in any said retail store and/or kiosk that the unique business entity maintains can then be utilized to subsidize the expense of establishing and maintaining such retail stores and/or kiosks.

78-87. (canceled)

88. The unique business entity, as described in claim 1) shall offer certain pre-made advertising packages, to be displayed on prior art digital signage apparatuses placed in retail stores or kiosk geographical locations as described in claim 77), for an extra fee as determined by the unique business entity, to paying members, or non paving members, as described in claim 94), or general advertisers that shall assist in the marketing/promoting/advertising paid memberships and/or any products and/or services and said pre-made advertising packages are, but not limited to, pre-produced commercials, infomercials, and other advertising bundles.

89-93. (canceled)

94. One such unique business entity that is described in claim 1) that utilizes the unique commerce model, method, and process, whether in whole or in part, as described in claim 1) is K.E.G. Distribution & Publishing, L.L.P and this unique business entity as described in claim 1) shall advertise and offer paid memberships and free memberships to any potential customer that the unique business entity desires to make such an offer to in the following manner:
a) potential customers that desire to become a non paying or paying member as described in claims 1) and 94) of the unique business entity as described in claim 1) must contact the company, through any means, and provide the unique business entity with their name, address, and contact information, including but not limited to, any information the unique business entity needs in general to contact the potential or paying customer, or needs to legally make payments to the paying or non paying member, and respectively, the unique business entity, as described in claim 1) must provide a paying or non paying member with any contact information necessary to conduct business and/or communication, whereas potential customers that desire to be paying members as described in claim 94) will also have to provide the unique business entity with payment, and corresponding information, that will allow the unique business entity to charge, on a designated reoccurring basis decided by the unique business entity, a fee to the potential customer so long as the potential customer desires to maintain and pay said fee to the unique business entity and the unique business entity shall, through any means, use, store, or otherwise collect contact information that the potential customer or paying member offers so that the unique business entity may contact the potential customer or paying member by any general communication means, for any reason, through traditional or nontraditional communication methods; furthermore, all business transactions, communication, advertisement, promotion, management of information and any and all other general business functions and/or operations, or executions of such function and/or operations, or technology used to conduct business or utilized by the unique business entity and/or the applied unique commerce model as described in claim 1) may be facilitated with or by, but is not limited to: computer technology, the internet, phone, text messaging, facsimile, radio, television, or wireless transmission, peer to peer wired and/or physical communication, written communication, and/or any other form of communication existing or not yet invented, and or the manual or automatic implementation of a functioning devices or devices, mechanical or otherwise that is used to assist any of the aforementioned criteria and,
b) the unique business entity as described in claim 1, shall create and host, on a secure server, a general e-commerce website that shall be used to help facilitate all business transactions, communication, advertisement, promotion, database management of information and all other general business functions and/or operations that such e-commerce websites typically help to assist with regard to general execution of commerce between any business entity and its customers, potential customers, merchants, retailers, employees or any other person or persons associated to any business entity that may benefit from the assistance of said e-commerce website and or any other function such e-commerce website may help to facilitate, whereas the e-commerce website that the unique business entity hosts is a facilitator of the unique commerce model as described in claim 1) of the unique business entity as described in claim 1) and is used as a facilitation device to execute a majority of general business functions and operations as described in claim 94a) of the unique business entity as described in claim 1) and optimally, potential customers of the unique business entity as described in claim 1) will contact the unique business entity and provide any information necessary as described in claim 94a) by logging on to the internet and using their web browser to enter the unique business entities website address while,
c) the unique business entity as described in claim 1) operates and maintains a general E-commerce website that is hosted on a secure server maintained by the unique business entity and once the potential customer is able to view the unique business entity's website, the potential customer will be given instructions via the website on how to accept: the membership offer and membership terms and condition, given a unique membership username and password to access certain portions of the website and/or the accompanying secure server that are not available to other paying or non paying members or the general public, instructions on how to provide any necessary information where a traditional shopping cart shall exist on the unique business entity's website that is linked to the websites' secure server and that will allow a potential customer or non paying member that desires to become a paying member the ability to make the first payment that initiates the non paying member's or potential customers' membership and a paying member shall maintain their paying membership and all benefits so long as they continue to allow and pay for said reoccurring charge whereas;
d) potential customers that have paid for a membership shall also be provided with access to the unique business entity's general e-commerce store so that they may purchase other products and/or services offered by the unique business entity at retail or member discounted prices, request additional products and/or services to be added to their membership for an additional fee, and other general e-commerce related functions and potential customers that have paid for a membership shall also be provided with access to personal or non personal tracking of information stored on a database that is hosted on the unique business entities secure server where those paying or non paying members shall receive, by the unique business entity as described in claim 1), a membership number that uniquely identifies them as a specific paying or non paying member and they may use this member number to:
e) offer to anyone that might need the specific member number to reference that particular paying or non paying member and that paying or non paying members should, or are at least encouraged, to provide interested new potential customers with their paying or non paying member's unique member number for reference purposes where any new potential customers may purchase a paid membership to the unique business entity as described in claim 1) from a paying or non paying member and those new potential customers may also enter information into the website via standard web-form such as the member and their respective member number of the person that referred them to the unique business entity) so that;
f) paying and non paying members as described in claim 8) shall receive a fixed commission in an amount determined by the unique business entity described in claim 1) for the sale of a paid membership of each and every new potential customer so long as that potential new customer executes the steps required as described in claim 94e) and paying members shall also receive a residual payment from and in an amount determined by the unique business entity described in claim 1) per each and every new customer the paying member refers to the unique business entity as described in claim 94e) so long as that potential new customer or customers maintains that membership, whereas;
g) the apparatus and facilitation device that is the general e-commerce website described in claim 94c) and associated function and execution as described in claim 94c) to facilitate general business functions, operations, transactions, and communications of the unique business entity as described in claim 1) that is utilized, executed, and/or applied in combination and in conjunction with either the unique model of commerce and/or the unique business entity's methods, systems and processes as described in claim 1) and throughout is exclusive and unique to the unique business entity as described in claim 1).

95. The unique business entity as described in claim 1) shall offer a fixed group, bundle or set of products and/or services that all paying members as described in claim 94) agree to automatically receive and own, or make use of, on a fixed and continued release cycle that is generally equivalent in time frame to that of all paying member's automatic payment schedule whereas, for example, if the paying member's future, predetermined and fixed payments that are automatically charged to the paying member on a fixed reoccurring and agreed upon release cycle is month to month, then the paying member shall also receive products and services as determined from the unique business entity on a month to month release cycle as well, and said products and services that paying members receive shall be different from release cycle to release cycle and these products and services shall be mailed, shipped, downloaded from the internet, delivered, or picked up from a predetermined location by the paying member, or received by any other delivery or customer receipt method and the ultimate facilitation and method of delivery of any product and/or service shall be determined by the unique business entity and the type, brand, style, variety or exact number of products and/or services that paying members of the unique business entity receive as is predetermined by the unique business entity and these paying members shall be made aware through the membership terms and conditions clause that they may, or may not have a choice, as to the exact products and/or services they shall receive and paying members shall agree upon purchasing a membership that such products and services, despite product and/or service variance are products and services that they ultimately desire to receive by agreeing to the terms and conditions clause.

96. Unique business entity's as described in claim 1) method and process for: determining initial and reoccurring pricing fees of membership for paying members as described in claim 94), price per each product and service procured and distributed, total volume or number of products and services to be shipped as described in claim 95), and number of products and or services included in each delivery also as described in claim 95) for each paying member as described in claim 94), is calculated by utilizing a mathematical formula created by the unique business entity which consists of many variables such as to charge each paying member as described in claim 94) a reoccurring fee as described in claim 94) that is approximately 24% above the total estimated cost to acquire, secure or create original products and services 3, produce, manufacture, and duplicate such product and/or service as described in claim 95), and deliver such product and service to all paying members of the unique business entity in a shipping cycle as described in claim 95), and approximately two or three products and or services as described in claim 95), should go out to each paying member per shipping cycle as described in claim 95) while the total expense for creating, acquiring, producing, manufacturing, duplicating and paying the owner or licensee of each single product and/or service to be shipped in a cycle to each paying member as described in claim 94) should not exceed 4%-6% of the total cost of one reoccurring membership fee, as described in claim 94), and the total expense for shipping or delivering each set of products and/or services shipped in a release cycle as described in claim 95) and should not exceed 10% of the total cost of one reoccurring membership fee, as described in claim 94), and 40% of each reoccurring membership fee per release cycle of all paying members is allocated to the unique entity's operational expenses per release cycle as described in claim 95), and approximately 4% of each reoccurring membership fee as described in claim 94) should be allocated to a fund designated for making residual payments as described in claim 94) to paying members per each release cycle as described in claim 95), and an additional approximate 4% of each reoccurring membership fee as described in claim 94) should be allocated to a fund designated for making incentive based, increased residual payments as described in claim 94) to paying members as described in claim 94) per each release cycle as described in claim 95), and approximately 45% of each initial or new membership fee as described in claim 94), of a referred paying member as described in claim 94) should be allocated as a commission payment to the referring non paying or paying member as described in claim 94).

97. A unique business entity as described in claim 1) can then use this formula or variance of it as described in claim 96) to make product and/or service “penetration pricing” offers to developers, owners, wholesalers or licensors of products and/or services that the unique business entity desires to distribute to its paying members as described in claim 95), based on predetermined volume [total number of paying members as described in claim 95)] that the unique business entity possesses and even if the unique business entity does not have or possess a certain volume when the offer is made, the unique business entity can still invite an owner, wholesaler or licensor of a product and/or service to quote their price per unit, based on specific volume levels of an upward sliding scale and correlating price per unit on a downward sliding scale, and then the owner, wholesaler or licensor of a product and/or service can then quote the unique business entity on exactly how much they expect to receive per unit of product and/or service, based on each corresponding volume level of the sliding upward scale, and assuming that the unique business entity shall pay for packaging the product and or service, shipping and handling whereas; this application of the mathematical formula as described in claim 96) combined with this product and/or service penetration pricing plan allows the unique business entity to essentially prospect the owners, wholesalers or licensor of various products and services without ever necessarily revealing the unique business entity's exact current volume level and the actual quote of the owner or licensor of service or product essentially becomes a variable gage or barometer that the unique business entity shall then utilize to proverbially “pull the trigger” on a specific line of product and/or service quoted at a specific price by the owner, wholesaler or licensor, when the unique business entity reaches a specific volume level or number of paying members so that the application of the formula as described in claim 96) along with this penetration pricing plan also may create excitement among the potential owner, wholesalers, or licensee of products and services as they usually want to sell their products and/or services in high volume, even if it is at low cost, because high volume sales usually is equated with greater market share and/or exposure for any product and/or service, which then often translates into more future customers; the system allows the unique business entity the opportunity to license and/or bulk purchase and release or otherwise distribute that same product and/or service to its customers at very low cost, while simultaneously allowing the unique business entity to know exactly what price per unit or product and/or service it can afford, based on its current total volume or total paying members as described in claim 96).

98. Any service can be distributed as described in claim 95) through the unique business entity as described in claim 1) to paying members as described in claim 94) by utilizing the unique business entities pricing formula and penetration pricing plan as described in claims 96) and 97) and then ship or otherwise allow paying members as described in claim 95) to receive a coupon, or make available some form of retrievable validation ticket (such as a downloadable coupon from the internet) or coupon that its paying members can then retrieve or acquire as described in claim 95) such business offering said services at no cost to the paying member and the unique business entity as described in claim 1) may also elect to add on an additional service or product to offer to its paying members as described in claim 94) should they elect to receive such additional products and/or services for a fee that is added on to their normal reoccurring fee as described in claim 94), whereas; the unique business entity would simply use its pricing formula and penetration pricing plan, as described in claims 96) and claim 97) to evaluate the expense and total cost of adding said additional product and/or service to each paying member that has requested to receive such product and/or service.

99. The unique business entity as described in claim 1) shall have a specific webpage on its e-commerce website, or otherwise make available to its paying members as described in claim 94), specific services or products that the paying members do not necessarily receive during their reoccurring release cycle as described in claim 95) and these products and services shall be severely discounted from their normal retail value, whereas the unique business entity shall sell such services and products at such a severely discounted rate because, unlike other traditional retail or e-commerce sales entities, the unique business entity earns the majority of its income from the monthly reoccurring fee as described in claim 94) paid by its paying members as described in claim 94); then the unique business entity that acquires and sells these specific products and services does not have to mark up the price of these products and or services at all to earn a profit and the unique business entity can simply negotiate to right to sell such products and services directly from the suppler, licensor, wholesaler or entity selling said products and services and then make these products and services available to paying members at nearly the same price, less any shipping and handling fees that would have to be paid by the paying members; then the unique business entity as described in claim 1) shall also sell on its e-commerce website, or make available, certain other specific products and or services to non paying members, paying members as described in claim 94), and the general public alike, and these products and services shall be, but are not limited to, products and services that were previously shipped out to paying members as described in claim 95) whereas paying members shall have the right to purchase these items at a discount while non paying members or the general public shall have to purchase these items at the suggested retail price.

100. The products and services as described in claim 95) by the unique business entity as described in claim 1) to paying members as described in claim 94) shall often be, but are not limited to, products and services that are actually created, financed, developed, produced, manufactured and/or otherwise procured, marketed, promoted and/or advertised by the paying members as described in claim 94) of the unique business entity and these products and/or services as described in claim 95) and claim 99) delivered to paying members as described in claim 95) by the unique business entity as described in claim 1) to paying members as described in claim 94) shall often be, but are not limited to, products and services that originated from emerging artists, musicians, filmmakers, video game developers, inventors, or any other group of individuals that inspire to create, finance, develop, produce, manufacture and/or otherwise procure, market, promote, advertise or otherwise expose a product and/or service to the unique business entity's paying members; thereby allowing the unique business entity's as described in claim 1) cross promotional marketing approach as described in claim 1) between product developers and product consumers respectively, that are the paying members as described in claim 94) creates a proverbial “vehicle” for product and/or service creation, “avenue” for product and/or service distribution and “toll booth” for product and/or service revenue generation for the unique business entity and its paying members who are selling said products and/or services, all within the built in membership community, whereas the consumer is often also the creator, the buyer and the seller of other consumers who are also often the creators, buyers, and sellers of various products and services as described in claim 95) and claim 99), all which assists in creating the unique model of commerce as described in claim 1).

101. The unique business entity as described in claim 1) shall attract new products and/or services and potential products and services that unique business entity shall either create, license, bulk purchase acquire and/or otherwise procure—to be delivered and/or received by its paying customers as described in claim 95) and to be sold otherwise on its e-commerce website as described in claim 94) through its own network of paying and non paying members as described in claim 94)—from the combination and variety of, but not limited to, the direct or indirect process and methods described herein and the unique business entity as described in claim 1) shall re-license, sublicense, lease or otherwise re-assign its unique licensing rights of certain intellectual properties, products and/or services that the unique business entity has acquired, created, and/or procured, by any means, process and/or method, to internal or external, affiliate or non affiliate, individuals, groups of individuals, merchants, publishers, distributors, wholesalers, retailers and/or any other business entity or entities and/or licensors that desire to obtain, purchase, own and/or otherwise share said licensing rights from (or with) the unique business entity, and for which the unique business entity shall negotiate the right to receive a percentage of revenue generated or profit participation, if any, from this transfer of its said licensing rights or the sale, resale, and/or lease of intellectual properties, products and/or services associated with said licensing rights.

102. The unique business entity as described in claim 1) shall pay:
a) any paying or non paying members as described in claim 94) or any other associates that have licensed or bulk sold products and/or services as described in claim 95) and claim 97) to the unique business entity—based on the unique business entity's formula and price per unit (or variation of) system as described in claim 96) and claim 97),—a fixed fee per unit for the associated products and/or services that are shipped out in a release cycle as described in claim 95), and;
b) any paying or non paying members, or any other associates that have licensed or bulk sold products and/or services as described in claim 102a), a royalty for each additional product and/or service sold on the unique business entities e-commerce website as described in claim 94) and claim 99) only after those products and services have been released in a cycle as described in claim 95), and;
c) any paying or non paying members, or any other associates that have licensed products and/or services as described in claim 102a), royalties for the re-licensing of that product and or/service as described in claim 101 and claim 102b).

103. Unique business entity as described in claim 1) shall create a unique tracking system that is designed to facilitate the scheduling process of the unique business entity's products and services as described in claim 95) that it may desire to include in its release cycles as described in claim 95), while simultaneously creating competition and incentive for participants—such as paying or non paying members as described in claim 94), who are inventors, artists, writers, musicians, filmmakers, video game developers and other individuals or entity that have licensed products, services, or intellectual property to the unique business entity and paying or non paying members who are selling paid memberships coupled with their own products and services that they are selling independently of the unique business entity—whom desire to have their respective said products, services, or intellectual property released in a shipping cycle as described in claim 95), and this unique tracking system and respective participants shall be placed in three different tiers created by the unique business entity as described in claim 1) whereas:
a) Tier 1 is composed of participants as described in claim 100) who have products and services as described in claim 95) that the unique business entity has selected and scheduled and;
b) Tier 2 is composed of participants as described in claim 100) that have products and services as described in claim 95) that are not scheduled to be released in a release cycle as described in claim 95), but that have an opportunity to compete to be rotated into Tier 1 and;
c) Tier 3 is composed of all participants as described in claim 100) that desire to compete or be rotated or otherwise upgraded into Tier 2 whereas; the unique business entity and commerce model as described in claim 1) is specifically designed to steadily increase its number of paying members as described in claim 94) as time progresses, therefore, and by default, any participant as described in claim 100) that is scheduled later in the unique business entity's twelve month schedule shall, by default, enjoy more volume (i.e. the unique business entity's total paying members) to sell to, if and/or when, their cycled release as described in claim 95) occurs; whereas the competition created by the unique business entity as described in claim 1) in conjunction with the scheduling system shall allow participants as described in claim 100) to compete in a general and specific fashion, dependant upon the specific tier that each participant is initially placed in by the unique business entity and participants with the highest total membership sales shall be placed first in their respective tier, with the remaining subsequent participants in that same tier, placed immediately behind the next in a sliding downward revolving scale that is calculated based on the participants combined respective total memberships sold within each tier and all participants shall be able to view and track their placement and progress by accessing the unique business entities website as described in claim 94) or other method the unique business entity chooses to reveal such information as described and furthermore; the unique business entity as described in claim 1) benefits from the promotions and sales of its paid memberships and the unique tracking system and its process and methods with regard to the scheduling process and competition amongst participants respectively, creates a means for the unique business entity to evaluate, track and allow the top selling tier participants to continue selling and promoting for as long as possible before they are evaluated by the unique business entity and upgraded into the next tier or ultimately scheduled for release in a cycle as described in claim 95), and the unique business entity ultimately decides if and when, or if at all, any of the tier participants as shall have their respective products and/or services released in a cycle as described in claim 95).

104. The unique business entity as described in claim 1) shall finance, fund, and/or cash flow its own certain new and original product and service creation, research, development, production and/or manufacturing and shall utilize its formula as described in claim 96) to evaluate and determine the amount of capital it can or may allocate from the unique business entity's operating capital in reserve (operating expenses) as described in claim 96) for the procurement and distribution of said certain new and original products and services whereas; upon evaluation, if the guaranteed earnings generated from memberships of paying members as described in claim 94), are greater than the estimated expense of procurement and distribution as described in claim 95), then the unique business entity shall finance, fund, and cash flow its own certain new and original products and services.

105. The unique business entity as described in claim 1) shall finance, fund, and/or cash flow certain other external new and original product and/or service creation, research, development, production and/or manufacturing by utilizing the process and method as described in claim 104) and these funds shall be allocated to paying or non paying members as described in claim 94), such as inventors, artists, writers, musicians, filmmakers, video game developers and other individuals or business entities that have licensed product and/or service concepts (or intellectual property concepts) to the unique business entity and paying or non paying members who are selling paid memberships coupled with their own new original product and/or service concepts and/or intellectual property concepts, all whom are attempting to finance the creation, development, production or manufacturing of said products, services and/or intellectual properties and whom desire to have those completed products and/or services released in a shipping cycle as described in claim 95) and have said completed products and/or services re-licensed by the unique business entity.

106. The unique business entity shall create a combined financing, co-production and distribution program specifically for motion picture producers and directors in need of production financing whereas motion picture producers approved by the unique business entity under this specific program shall enter into a co-production agreement with the unique business entity, and as per the co-production agreement, a motion picture producer must option their literary property (screenplay) and license the resulting completed motion picture procured through the program to the unique business entity in exchange for possible financial assistance, guaranteed financial assistance, and a guaranteed distribution of their motion picture to be released in a cycle as described in claim 95) and claim 99), coupled with the potential of earning royalties as described in claim 102b) and c) and potential of earning additional royalties from a re-licensing deal as described in claim 102 c, where the unique business entity shall allow approved motion picture producers utilizing this program to submit a motion picture budget to the unique business entity and then create a team of non paying or paying members (i.e. the cast and crew, friends, family, or any other supporter of the motion picture and or motion picture producer) to pool membership commissions earned and any residuals earned from referrals as described in claim 94) whereas; the pooled commissions and residuals shall be placed in an escrow account set up by the unique business entity and the motion picture producer, or a secured account maintained by the unique business entity, and when the motion picture producer and team have secured enough funds to begin production on the motion picture from the execution of this practice (in accordance to the budget submitted by the motion picture producer), the unique business entity shall release the escrowed funds to the motion picture producer so that the motion picture producer may execute the production of the motion picture, or, if the co-production agreement between the unique business entity and the motion picture producer expires after a certain period of time designated by the unique business entity, or, should the motion picture producer not secure enough funds for the production before the co-production agreement expires, then the co-production agreement can either be renegotiated or cancelled by the unique business entity, or if no motion picture has been produced, then the unique business entity shall release all escrowed and/or secured commissions and/or residuals back to each individual paying or non paying member who initially elected to have their commissions and/or residuals retained for the purpose of raising funds for the motion picture.

107. The combined financing, co-production and distribution program as described in claim 106) shall also allow motion picture producers the ability to couple funds secured as described in claim 106) with motion picture investment and motion picture producers approved by the unique business entity and who have entered into a co-production agreement as described in claim 14) may seek out investments from private investors interested in investing in the motion picture so that the combined financing, co-production and distribution program shall greatly enhance the motion picture producers probability for securing investment because the motion picture shall already have a guaranteed distribution deal from the unique business entity as described in claim 106) that allows for certain guaranteed investments returns from the motion picture being released in a cycle as described in claim 95) and corresponding earnings generated from such release as described in claim 102) if the distribution of the motion picture in a release cycle as described in claim 95), and if the corresponding earnings generated as described in claim 102) is not enough to recoup the motion picture investor/s initial investment, the co-production agreement as described in claim 106) may allow the motion picture producer's investor/s to earn any pooled residual payments of the motion picture's producer and/or team as described in claim 106) until which time the motion picture investor/s have recouped their entire investment.

108. The unique business entity shall create an affiliate concept unique tracking system that shall utilize the process and method for execution as described in claim 10), but shall apply such execution to any uncompleted product and/or service concept that the developers and/or creators of said uncompleted product and/or service concept desire to have financed by the unique business entity as described in claim 14) and released in a cycle as described in claim 95).

109. The unique business entity as described in claim 1) shall utilize the distribution channels as described and defined in claim 95) of all of its paying members as described in claim 94) and pay external individuals and/or businesses such as, but not limited to, video game developers, motion picture producers, musicians and inventors to beta test or test market certain products and/or services on the unique business entities' paying members as described in claim 94), and the unique business entity shall occasionally offer said beta test, test market or otherwise prototype products and/or services to its paying members as described in claim 95), as opposed to completed products and/or services also described in claim 95), and said prototype products and or services shall be delivered to all paying members as described in claim 95) whereas; utilizing the formula as described in claim 96), the unique business entity shall pay said video game developers, motion picture producers, musicians and inventors to release any prototype product and/or services while interested paying members may then enjoy the prototype product and/or service as well as give specific and necessary feed back to the unique business entity in any method the unique business entity creates to set up the communication of such feed back as described in claim 94), and then the unique business entity shall forward any feedback to said video game developers, motion picture producers, musicians and inventors or other testers of product and/or services, and shall encourage individuals and businesses that are testing prototype products and/or services to further beta test or test market said prototype products and/or services on specific paying members that provided the best feedback (as determined by the individuals and businesses requesting said additional feedback and/or tests), and then the unique business entity shall pay the selected paying members and testers an hourly wage to perform said comprehensive or further testing as determined by the individuals and/or businesses that are testing prototype products and/or services.
